(19) United States
(12) Patent Application Publication
(10) Pub. No.: US 2009/0128332 A1
(43) Pub. Date: May 21, 2009

(54) RFID-ENABLED HOLOGRAM LASER TAG

(75) Inventor: Sui-Feng Lu, Taipei (TW)

Correspondence Address: WPAT, PC, 7225 BEVERLY ST., ANNANDALE, VA, 22003, US

(73) Assignee: CLARIDY SOLUTIONS, INC., Taipei (TW)

(21) Appl. No.: 11/940,576

(22) Filed: Nov. 15, 2007

(51) Int. Cl. G08B 13/14

(52) U.S. Cl. 340/572.1

(57) ABSTRACT

An RFID-enabled hologram laser tag is disclosed, which is primarily comprised of: a hologram substrate; and a radio frequency identification (RFID) module, including an RFID chip; wherein the RFID module is configured into the hologram substrate so as to use a conducting layer of the substrate as an antenna of the RFID module. In a preferred embodiment, the RFID chip can be modularized with another conductive substrate so as to form an interface module, with which the coupling of the hologram substrate with the RFID chip is facilitated. Operationally, as the RFID-enabled hologram laser tag is attached to an object, the position and other relating information of the object can be identified and acquired through the RF signals of the RFID chip so that the RDIF-enabled hologram laser tag, not only is decorative, but also can use the RFID technology to automatically tracking and identification the object attached thereby.

### FIELD OF THE INVENTION

The present invention relates to an RFID-enabled hologram laser tag, and more particularly, to a decorative and counterfeit-proof RFID-enabled hologram laser tag capable of being attached to an object for acquiring the position and other relating information of the object through the RF signals of the RFID chip fitted therein so that the RDIF-enabled hologram laser tag can automatically track and identify the object for a management purpose and thus is suitable to be adapted as security label or RFID tag, etc.

### BACKGROUND OF THE INVENTION

Recently, the demand for anti-counterfeit holographic label is increasing rapidly since, comparing to other anti-counterfeit technology, it is the only product that not only can be used for consumer protection, but also can protect manufactures against counterfeiting and brand exploitation. As shown in FIG. 1, a conventional anti-counterfeit holographic label 10 is substantially a plastic substrate 12 with a metal coating 11, on which, by the use of a mold manufactured by a laser means, a two- or three-dimensional holographic pattern is molded and formed. Moreover, an adhesive layer 13 and a layer of release liner 14 are successively applied onto the metal coating 11 so as to accomplish the whole anti-counterfeit holographic label 10. By attaching the aforesaid anti-counterfeit holographic label 10 on a well-established brandname product, not only it can be used for anti-counterfeiting, but also the value of the brandname product is enhanced. However, although the aforesaid conventional holographic label did achieve certain anti-counterfeiting effects because of its requiring to be made by the use of high priced laser means and complicated manufacturing process, and thus incapable of being copied by ordinary printing means, it is no longer sufficient to cope with the capabilities of today's counterfeiters as they are improving their skill in a fast pace. Thus, the anti-counterfeit ability of the aforesaid holographic label is reinforced by techniques, such as the one-time anti-tear design, or serial code identifiable only by specific machines, and so on. In spite of all those improvements, the aforesaid holographic label is still a one-way passive device, by which it is difficult for a common consumer to check its authenticity just by comparing, and in addition, manufacturers can not be informed in real time when the holographic label is being torn off or damaged. To sum up, when manufacturers aware of the counterfeiting of their products, the best opportunity of tracing and capturing the counterfeiter had already been lost.

One such conventional holographic label is the one disclosed in U.S. Pat. No. 6,618,024, entitled “Holographic Label With a Radio Frequency Transponder”, as shown in FIG. 2. In FIG. 2, the holographic label with a radio frequency (RF) transponder is successively comprised of a holographic image layer 40, a reflective layer 36, an inlay layer 22, an adhesive layer 18, a release liner 16, while sandwiching a layer of RF transponder circuit 26 and an antenna layer 24 connected to the RF transponder circuit 26 between the reflective layer 36 and the inlay layer 22. In order to prevent the transmitting and receiving of the RF transponder circuit 26 from being interfered by the metallic pattern of the holographic image layer 40, both the reflective layer 36 and the inlay layer 22 must be made of a non-conductive or non-metal material. It is noted that the aforesaid label is simply a stacking structure of a holographic label and an RF transponder and is required to be structured with the reflective layer 36 and the inlay layer 22 just for preventing the interference between the RF transponder and the holographic label. Resulting from that the aforesaid holographic label with an RF transponder is not only disadvantageous in its complex structural design and high manufacturing cost, but also its overall thickness is increased.

Another improvement is a transparent transaction card disclosed in TW Pat. Appli. No. 92131042. The aforesaid card, being a multifunctional card, is designed to have holographic metal foil, radio frequency identification (RFID) circuit and antenna, and magnetic stripe to be formed therein so as to enable to card to be multifunctional. However, it is similar to the foregoing U.S. patent and is structured by simply stacking a variety of components of different functionalities.

### SUMMARY OF THE INVENTION

In view of the disadvantages of prior art, the primary object of the present invention is to provide an RFID-enabled hologram laser tag, being a device integrating functionalities of holographic label and RFID tag, that is able to responds to a radio frequency interrogation signal automatically for tracking and acquiring information relating to an object to which the tag is attached, and also is able to identify the authenticity of the object by the holographic pattern formed on the tag.

To achieve the above object, the present invention provides an RFID-enabled hologram laser tag, comprising: a hologram substrate; and a radio frequency identification (RFID) module, including an RFID chip; wherein the RFID module is configured into the hologram substrate so as to use a conducting layer of the substrate as an antenna of the RFID module. In a preferred embodiment, the RFID chip can be modularized with a conductive substrate so as to form a capacitive-coupling interface module, with which the coupling of the hologram substrate with the RFID chip is facilitated.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 shows a conventional holographic label.

FIG. 2 is a cross-sectional view of a holographic label with RF transponder disclosed in U.S. Pat. No. 6,618,024.

FIG. 3A is a front view of an RFID module adapted for an RFID-enabled hologram laser tag according to an exemplary embodiment of the invention.

FIG. 3B is a bottom view of FIG. 3A.

FIG. 4A is a front view of an RFID-enabled hologram laser tag according to an exemplary embodiment of the invention, whereas the RFID module is configured into the hologram substrate.

FIG. 4B is a bottom view of FIG. 4A.

FIG. 5A is a front view of an RFID-enabled hologram laser tag according to another exemplary embodiment of the invention, whereas the RFID module is configured into the hologram substrate.

FIG. 5B is a bottom view of FIG. 5A.

FIG. 6A is a front view of an RFID-enabled hologram laser tag according to yet another exemplary embodiment of the invention, whereas the RFID module is configured into the hologram substrate.

FIG. 6B is a bottom view of FIG. 6A.

FIG. 7A is a front view of an RFID module adapted for an RFID-enabled hologram laser tag according to another exemplary embodiment of the invention.

FIG. 7B is a bottom view of FIG. 7A.

FIG. 8A is a front view of an RFID-enabled hologram laser tag according to further another exemplary embodiment of the invention, whereas the RFID module is configured into the hologram substrate.

FIG. 8B is a bottom view of FIG. 8A.

FIG. 9A is a front of an RFID-enabled hologram laser tag according to an exemplary embodiment of the invention, whereas the RFID chip is being attached directly upon the hologram substrate.

FIG. 9B is a bottom view of FIG. 9A.

FIG. 10 is a front view of an RFID module adapted for an RFID-enabled hologram laser tag according to yet another exemplary embodiment of the invention.

FIG. 11 is a front view of an RFID-enabled hologram laser tag, whereas the RFID chip is attached directly onto the hologram substrate.

FIG. 12 is a front view of an RFID module adapted for an RFID-enabled hologram laser tag according to yet further exemplary embodiment of the invention.

FIG. 13 is a front view of an RFID-enabled hologram laser tag, whereas the RFID chip used in the RFID module of FIG. 12 is attached directly onto the hologram substrate.

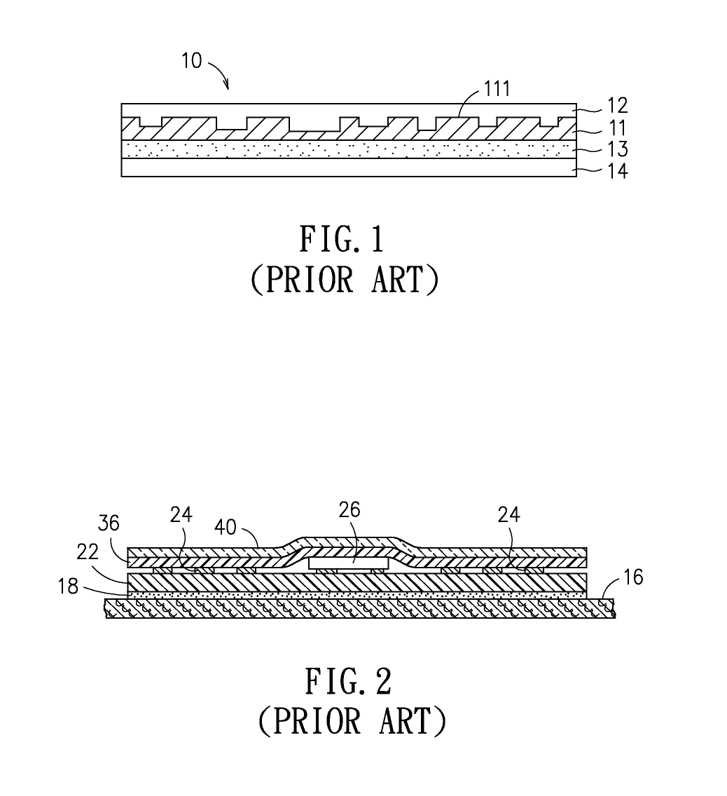

### DESCRIPTION OF THE EXEMPLARY EMBODIMENTS

For your esteemed members of reviewing committee to further understand and recognize the fulfilled functions and structural characteristics of the invention, several exemplary embodiments cooperating with detailed description are presented as the follows.

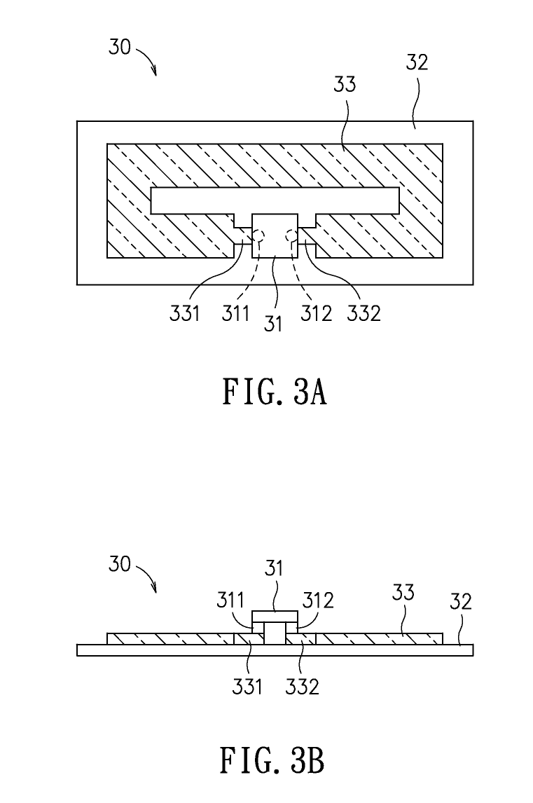

Please refer to FIG. 3A and FIG. 3B, which show an RFID-enabled hologram laser tag according to an exemplary embodiment of the invention, whereas the RFID module is configured into the hologram substrate. The RFID-enabled hologram laser tag includes an RFID module 30, which is composed of: a base 32; and a conducting layer 33 arranged on the base 32; wherein, there are two separate legs 331, 332 being disposed at the center portion of the conducting layer 33 in a symmetrical manner; and an RFID chip 31 is sandwiched between the two legs 331, 332. As shown in FIG. 3B, the RFID chip 31 is configured with two bumps 311, 312, that are respectively connected to the two poles of the RFID chip 31 while electrically connecting to the RF circuit, logic circuit and memory of the RFID chip 31. It is noted that the two bumps 311, 312 can be made of a single conductive metal, or an alloy of a plural conductive metals. Generally, there are bonding pad being formed on the two poles of the RFID chip so that the bumps 311, 312 can be attached upon the bonding pads by welding, however, it is known to those skilled in the art and thus is not described further herein. Preferably, the base 32 can be either flexible or rigid and made of a non-conductive material. If the base 32 is flexible, it should be made of a plastic, such as PET (polyester), PI (polyimide) or FR4. Moreover, the conducting layer 33 can be made of a single conductive metal, or an alloy of a plural conductive metals. In an exemplary embodiment, the legs 331, 332 are jointed with the bumps 311, 312 either by welding or by gluing by which the RFID chip 31 is electrically connected to the conducting layer 33.

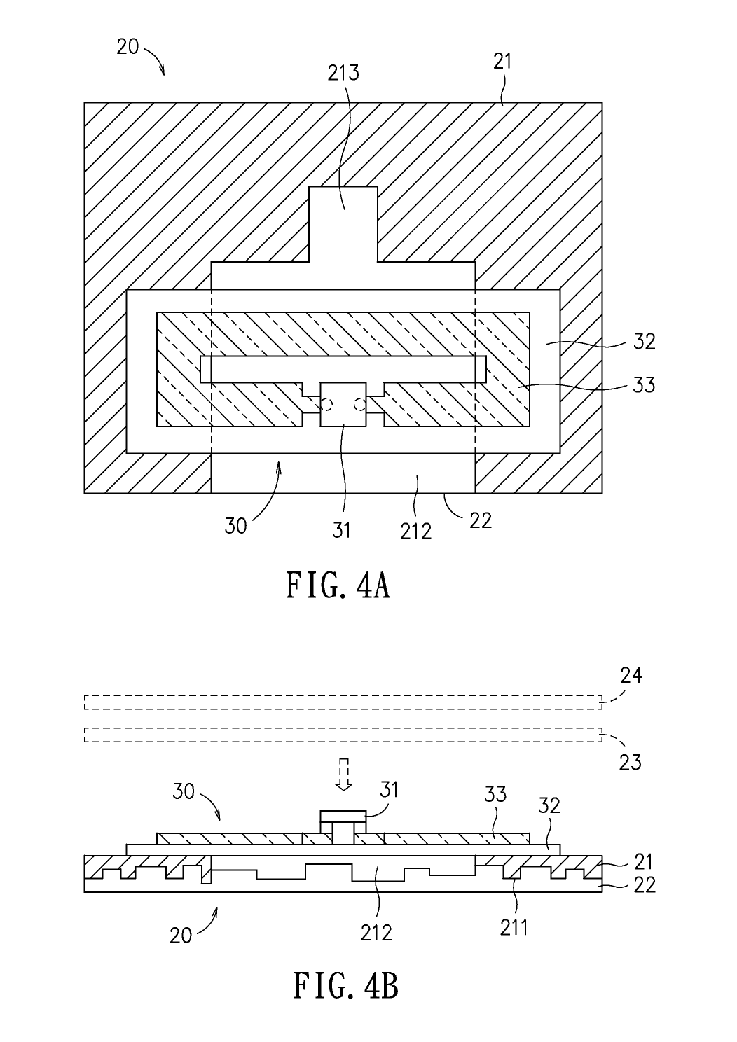

In FIG. 4A and FIG. 4B, the RFID module 30 is disposed on a hologram substrate 20, which includes: a metal layer 21, having a holographic pattern 211 formed thereon by an imprinting process; and a surface layer 22, being formed on top of the patterned surface of the metal layer 21. Preferably, the metal layer 21 is substantially an aluminum coating, and the surface layer 22 is made of a transparent plastic, such as polyethylene terephthalate (PET), oriented polypropylene (OPP), and polyvinyl chloride (PVC), and the mixture thereof. In an exemplary embodiment of the invention, the metal layer 21 of the hologram substrate 20 is configured with a recess portion 212 and a groove 213. Moreover, the recess portion 212 is formed along a side of the metal layer 21 in a manner that the side is dented to form a concave; and the groove 213, being a bar-like structure, is extending on the metal layer 21 while having an end thereof channeling to the recess portion 212.

As the RFID module 30 is mounted on the metal layer 21 at a position corresponding to the recess portion 212 in a manner that the RFID module 30 is striding across the recess portion 212, the two longitudinal sides of the base 32 of the RFID module 30 are placed to rest on the metal layer 21 respectively at areas neighboring to the recess portion 212. Thereby, the conducting layer 33 can be capacitively coupled to the metal layer 21 through the base 32 so that the metal layer 21 is able to function as the antenna of the RFID chip 31. After the RFID module 30 is integrated with the hologram substrate 20, an adhesive layer 23 and a layer of release liner 24 are successively formed on the RFID module 30, and thus an RFID-enabled hologram laser tag is established.

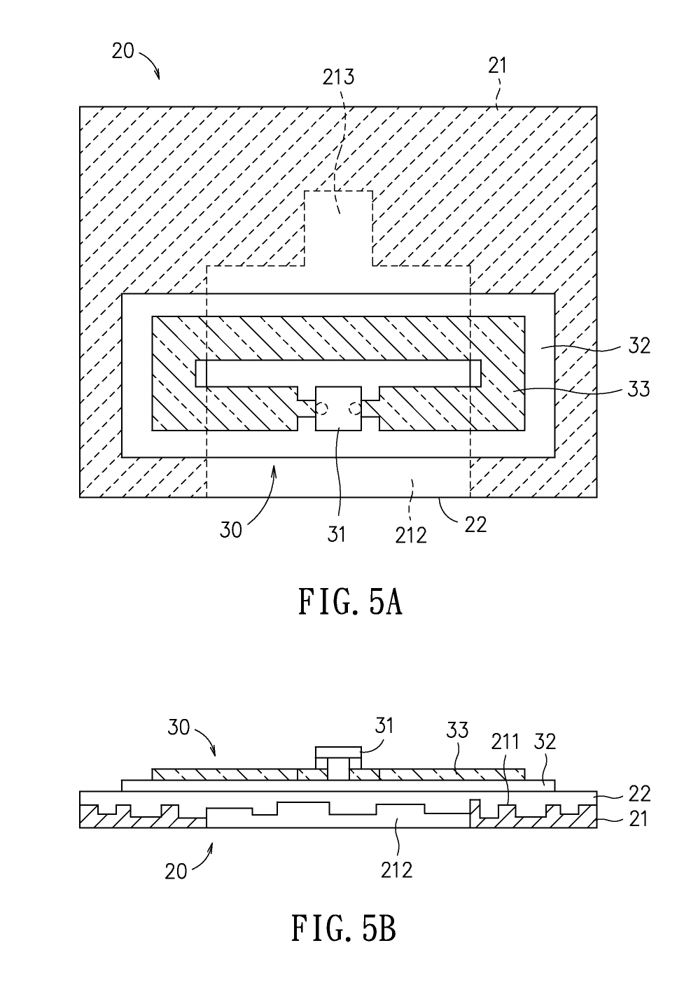

The RFID-enabled hologram laser tag shown in FIG. 5A and FIG. 5B is similar to that shown in FIG. 4A and FIG. 4B that it is also a device integrating an RFID module 30 and a hologram substrate 20. Although the functions and structures of the RFID module and the hologram substrate 20 are the same, the RFID-enabled hologram laser tag of FIGS. 5A and 5B is characterized in that instead of fitted to the metal layer 21, its RFID module 30 is mounted on the surface layer 22 of the hologram substrate 20, and thereby, the conducting layer 33 also can be capacitively coupled to the metal layer 21 through the base 32 and the surface layer 22 so that the metal layer 21 is able to function as the antenna of the RFID chip 31.

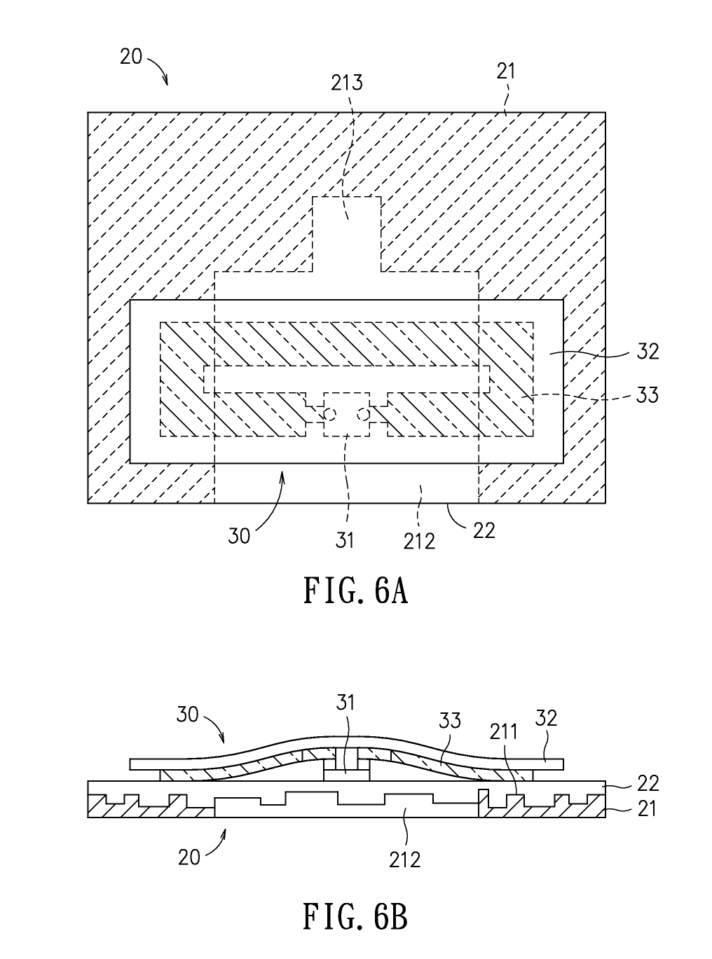

Moreover, the e RFID-enabled hologram laser tag shown in FIG. 6A and FIG. 6B is similar to that shown in FIG. 5A and FIG. 5B that it is also a device integrating an RFID module 30 and a hologram substrate 20. Although the functions and structures of the RFID module and the hologram substrate 20 are the same, the RFID-enabled hologram laser tag of FIGS. 6A and 6B is characterized in that the mounting of the RFID module 30 is realized by attaching the conducting layer 33 of the RFID module 30 directly at the surface layer 22 of the hologram substrate 20, and thereby, the conducting layer 33 also can be capacitively coupled to the metal layer 21 through the surface layer 22 so that the metal layer 21 is able to function as the antenna of the RFID chip 31. Similarly, by flipping over the hologram substrate 20 for positioning the surface layer 22 at the bottom thereof, as that shown in FIG. 4B, instead of attaching the conducting layer at the surface layer 22, it can be attached upon the metal layer of the hologram substrate 20 for inductively coupling the two and thus enabling the metal layer 21 to function as the antenna of the RFID chip 31.

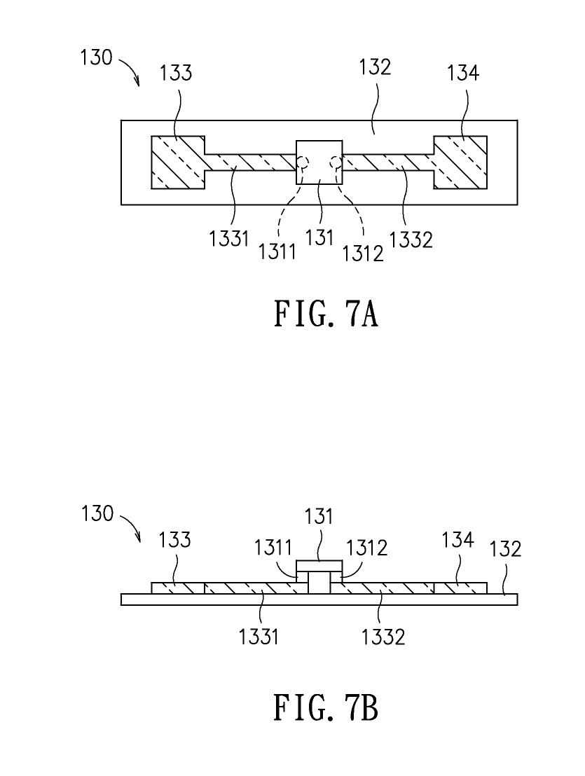

Please refer to FIG. 7A and FIG. 7B, which shown an RFID module adapted for an RFID-enabled hologram laser tag according to another exemplary embodiment of the invention. In this embodiment, the RFID module 130 is composed of: a base 132; and two separate conducting layers 133, 134, being arranged on the base 32 symmetrically; wherein, there are two separate legs 1331, 1332 being disposed respectively at the two symmetrically disposed conducting layers 133, 164 while the two legs 1331, 1332 are joined respectively to two bumps 1311, 1312 of the RFID chip 131 either by gluing or by welding. It is noted that the functions of and materials used in the RFID chip 131, the base 132 and the conducting layers 133, 134 are all the same as those shown in FIG. 3A and FIG. 3B, and thus are not described further herein.

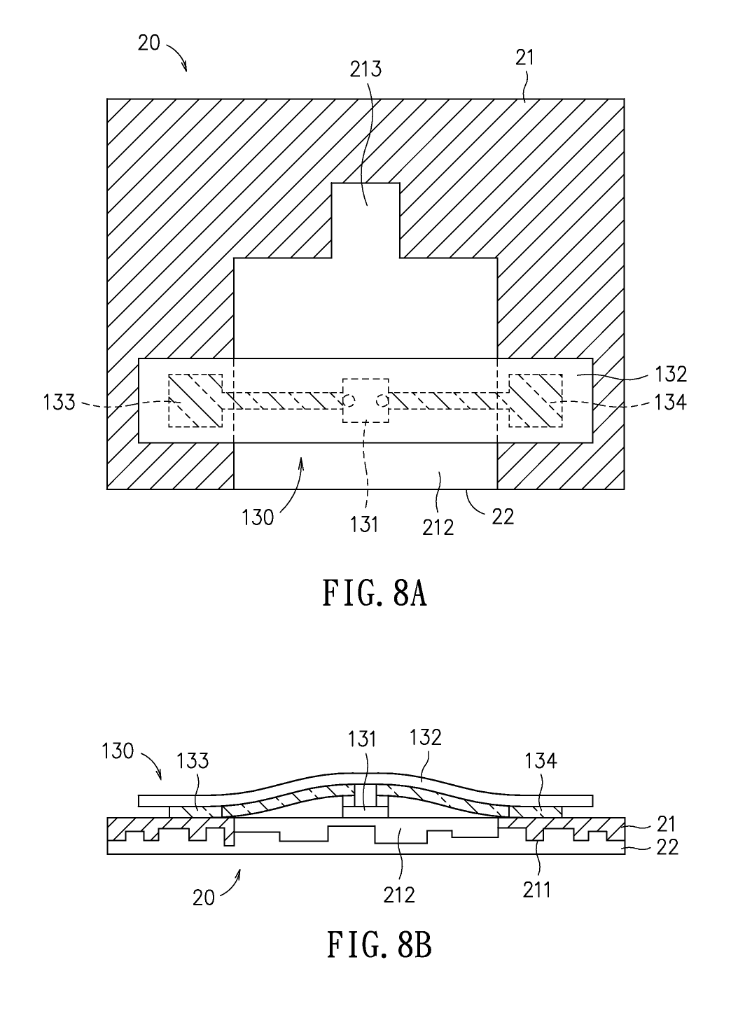

Similarly, the aforesaid RFID module can be configured into a hologram substrate 20 as shown in FIG. 8A and FIG. 8B. In FIG. 8A and FIG. 8B, the mounting of the RFID module 130 is realized by attaching the conducting layers 133, 134 of the RFID module 130 directly at the metal layer 21 of the hologram substrate 20, and thereby, the conducting layers 133, 134 can be inductively coupled to the metal layer 21 so that the metal layer 21 is able to function as the antenna of the RFID chip 131. Similarly, by flipping over the hologram substrate 20 or by flipping over the RFID module 131, instead of attaching the conducting layers 133, 134 at the metal layer 21, they can be joined with the surface layer 22 of the hologram substrate 20 for capacitively coupling the two and thus also capable of enabling the metal layer 21 to function as the antenna of the RFID chip 131.

It is emphasized that the areas as well as the shapes of those metal layer 21, recession portion 212 and groove 213 can also be varied with respect to actual requirement and thus are not limited by those illustrated in the foregoing embodiments. For instance, the metal layer 21 can be designed to shape like a rectangle, a circle, a polygon or any irregular shape, only if it is matched with the shape of the hologram substrate 20, which is the same to the recess portion 212. In addition, the extending of the groove 213 not only can be defined by a straight line, but also can be defined by a curved line or the combination of straight line and curved lines.

As the RFID chip 31, the base 32 and the conducting layer 33 used in the present invention is modularized into the RFID module 30, the manufacturing of the RFID-enabled hologram laser tag can be performed by the process of making a hologram substrate 20 with one additional procedure for configuring the RFID module 30 into the hologram substrate 20. On the other hand, it is certainly feasible to incorporate the laminating of the RFID chip, the base 32 and the conducting layer 33 into the manufacturing process of the hologram substrate 20, in that after formation and pattern of the metal layer is accomplished, first the base 32 and the conducting layer 33 are successively being laminated upon the metal layer 21, and then the RFID chip 31 is joined to the conducting layer, thereafter, the adhesive layer and the release liner are laminated so as to accomplish an RFID-enabled hologram laser tag.

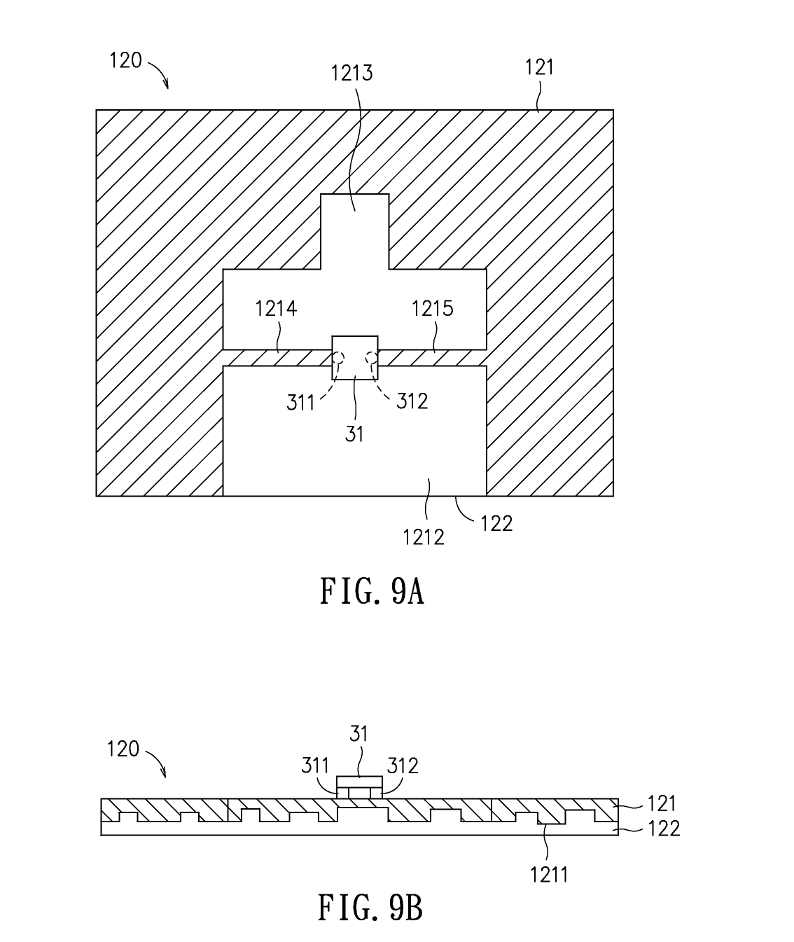

In FIG. 9A and FIG. 9B, the RFID module 30 is disposed on a hologram substrate 120, which includes: a metal layer 121, having a holographic pattern 1211 formed thereon by an imprinting process; and a surface layer 122, being formed on top of the patterned surface of the metal layer 21. Similar to the substrate 20 shown in FIG. 4A, the metal layer 121 of the hologram substrate 120 is configured with a recess portion 1212 and a groove 1213. Although the functions of the metal layer 121, surface layer 122, recess portion 1212 and groove 1213 are the same as those shown in FIG. 4A, the present embodiment is characterized in that: there are two legs 1212 being respectively formed as the extensions of the metal layer 121 in symmetrical manner, which can function similar to the legs 331, 332 shown in FIG. 3A, and the legs 1331, 1332 shown in FIG. 7A. By mounting the RFID chip 31 on the two legs 1214, 1215 and joining the two bumps 311, 312 of the RFID chip 31 to the two legs 1214, 1215 in respective, the RFID chip 31 is electrically connected to the metal layer 1212 so that not only the hologram pattern of the metal layer 121 can be used for anti-counterfeiting, but also it can be used as the antenna of the RFID chip 31. Thereby, not only manufacturing cost is reduced, but also its overall thickness is decreased.

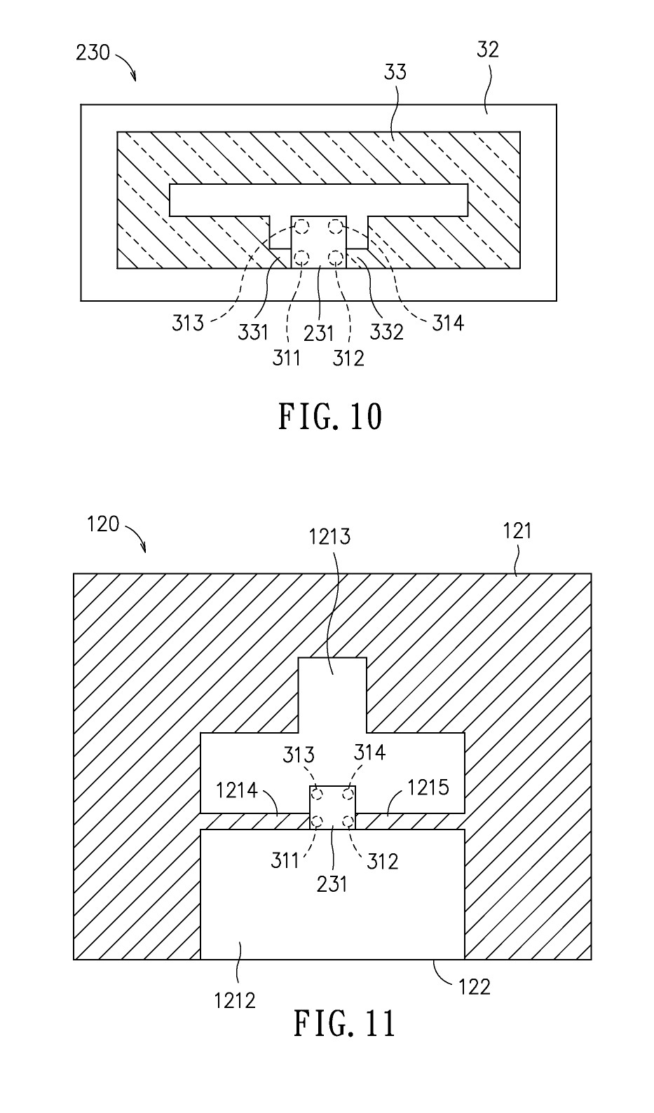

In FIG. 10, an RFID module 230 is composed of: a base 32; and a conducting layer 33 arranged on the base 32; wherein, there are two separate legs 331, 332 being disposed at the center portion of the conducting layer 33 in a symmetrical manner; and an RFID chip 231 is sandwiched between the two legs 331, 332, which are all functioned and structured similar to those shown in FIG. 3A and thus are not described further herein. The characteristics of the present embodiment is that: there are four bumps 311, 312, 313, 314 being formed and positioned at the for corners of the RFID chip 231, which are used not only for stabilizing the disposition of the RFID chip 231, but also as terminals for connecting the internal circuit of the RFID chip with other components of the RFID module 230. In this exemplary embodiment, the two bumps 311, 312 are respectively connected to the two legs 331, 332 formed at the center portion of the conducting layer 33 in the RFID module 230, so that the RFID chip 231 can use the conducting layer 33 as its antenna. In addition, if the RFID module 230 is configured with two conducting layer and another two bumps 313, 314 are connected to another conducting layer for using the same as another antenna, the RFID chip 231 is substantially equipped with two antennas. It is noted that the RFID module 230 of FIG. 10 can be configured into the hologram substrate similar to those shown in FIG. 4A˜FIG. 6A. Moreover, the RFID chip 231 used in the present embodiment can be replaced and substituted by the RFID chip 131 of FIG. 7A while maintaining the same functionality.

Please refer to FIG. 11, which is a front view of an RFID-enabled hologram laser tag, whereas the RFID chip is attached directly onto the hologram substrate. In FIG. 11, the RFID chip 231 formed with four bumps 311, 312, 313, 314, as that shown in FIG. 10, is joined directly with a hologram substrate 120, whereas the hologram substrate 120 is the lamination of a metal layer 121 and a surface layer 122, in which a metal layer 121 is comprised of a recession portion 1212 having two legs 1214, 1215 formed therein and a groove 1213. Similarly, the two bumps 311, 312 are respectively connected to the two legs 1214, 1215 either by welding or gluing, so that the RFID chip 231 can use the metal layer 121 as its antenna. In addition, another two bumps 313, 314 can be connected to another conducting layer for using the same as another antenna, and thus, the RFID chip 231 is substantially equipped with two antennas.

It is noted that except for the two-bumped RFID chip shown in FIG. 3A and the four-bumped RFID chip shown in FIG. 10, there are other RFID chip current available on the market, one of which is a six-bumped RFID chip. For the six-bumped RFID chip, it is feasible to configure a holographic label with six antennas, and so on.

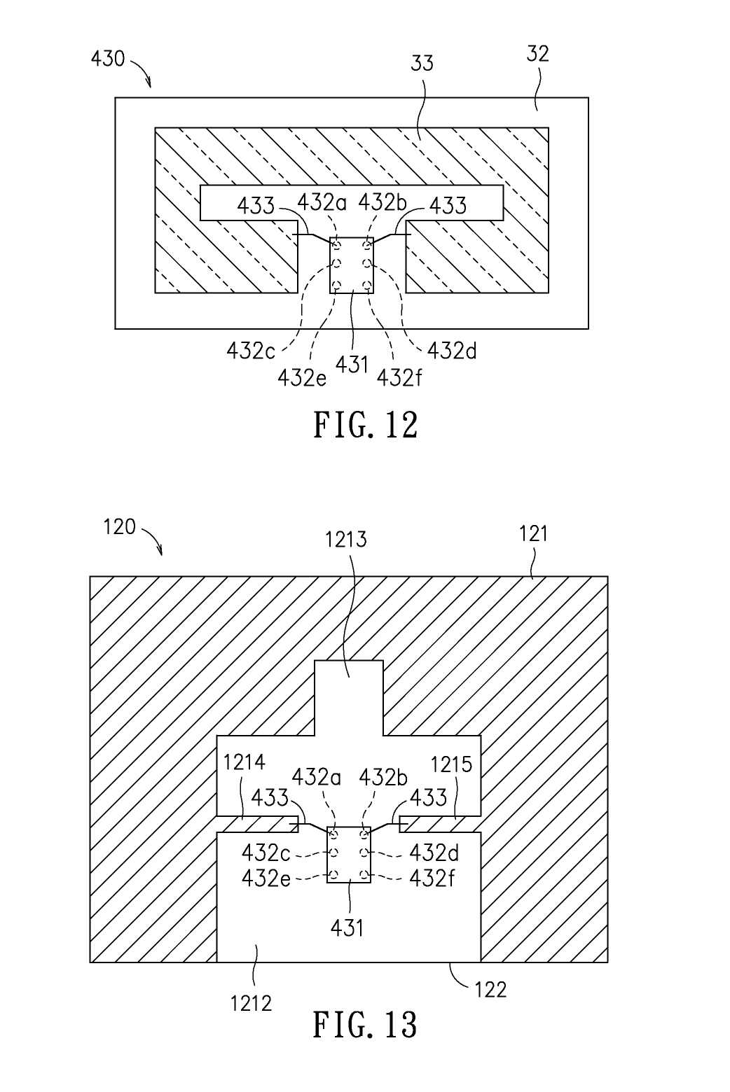

In FIG. 12, an RFID module 430 is composed of: a base 32; a conducting layer 33 arranged on the base 32, and an RFID chip 431 mounted on the base 32, which are all functioned and structured similar to those shown in FIG. 3A and thus are not described further herein. The characteristics of the present embodiment is that: there are six bonding pads 432a˜432f formed on the RFID chip 431, in which two bonding pads 432a, 432b are connected to the twp poles of the RFID chip 431 and the same time that are connected to the conducting layer 33 by bonding wires 433 so as to electrically connecting the RFID chip 431 with the conducting layer 33. It is noted that the RFID module 430 of FIG. 12 can be configured into the hologram substrate similar to those shown in FIG. 4A˜FIG. 6A. Moreover, the RFID chip 431 used in the present embodiment can be replaced and substituted by the RFID chip 131 of FIG. 7A while maintaining the same functionality.

Obviously, the RFID chip 431 with six bonding pads 432a˜432f is capable of being joined directly with the hologram substrate 20. In FIG. 13, the RFID chip 431 formed with six bonding pads 432a˜432f, as that shown in FIG. 12, is joined directly with a hologram substrate 120, whereas the hologram substrate 120 is the lamination of a metal layer 121 and a surface layer 122, in which a metal layer 121 is comprised of a recession portion 1212 having two legs 1214, 1215 formed therein and a groove 1213. Similarly, the two bonding pad 432a, 432b are respectively connected to the two legs 1214, 1215 either by bonding wires, so that the RFID chip 231 can use the metal layer 121 as its antenna. It is noted that the positioning of the RFID chip is dependent upon the design of the metal layer 121 while the two legs can be arranged with respect to actual requirement. In addition, the other four bonding pads 432c˜432f can be paired while connecting different pairs to different conducting layers of the RFID module, and thereby, the RFID chip 231 can be equipped with three antennas.

To sum up, the present invention is intended to provide an RFID-enabled hologram laser tag, being a device integrating a hologram substrate and a RFID module and thus capable of using the metal layer of the hologram as the antenna of the RFID module, that is able to responds to a radio frequency interrogation signal automatically for tracking and acquiring information relating to an object to which the tag is attached, and also is able to identify the authenticity of the object by the unique and decorative holographic pattern formed on the tag.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An RFID-enabled hologram laser tag, comprising:
a hologram substrate, including a conductive metal layer; and
a radio frequency identification (RFID) module, including:
at lease a base, made of a non-conductive material;
at least a conducting layer, arranged on the base;
an RFID chip, arranged on the base while electrically connecting the two poles of the RFID chip to the conducting layer in respective;
wherein the RFID module is configured into the hologram substrate while electrically connecting the conducting layer of the RFID chip to the metal layer of the hologram substrate.

2. The RFID-enabled hologram laser tag of claim 1, wherein the hologram substrate further comprises:
a metal layer, having a pattern formed thereon by a formation process; and
a surface layer, made of a transparent plastic material, being formed on top of the patterned surface of the metal layer.

3. The RFID-enabled hologram laser tag of claim 2, wherein the base of the RFID module is configured to integrate with the surface layer of the hologram substrate for capacitively coupling the conducting layer of the RFID module to the metal layer of the hologram substrate.

4. The RFID-enabled hologram laser tag of claim 2, wherein the base of the RFID module is configured to integrate with the metal layer of the hologram substrate for capacitively coupling the conducting layer of the RFID module to the metal layer of the hologram substrate.

5. The RFID-enabled hologram laser tag of claim 2, wherein the conducting of the RFID module is configured to integrate with the surface layer of the hologram substrate for capacitively coupling the conducting layer of the RFID module to the metal layer of the hologram substrate.

6. The RFID-enabled hologram laser tag of claim 2, wherein the conducting of the RFID module is configured to integrate with the metal layer of the hologram substrate for electrically connecting the conducting layer of the RFID module to the metal layer of the hologram substrate.

7. The RFID-enabled hologram laser tag of claim 2, wherein the surface layer of the hologram substrate is made of a plastic selected from the group consisting of polyethylene terephthalate (PET), oriented polypropylene (OPP), and polyvinyl chloride (PVC), and the mixture thereof.

8. The RFID-enabled hologram laser tag of claim 2, wherein the hologram substrate further comprises:
an adhesive layer; disposed on the metal layer; and
a release liner, adhering to the adhesive layer.

9. The RFID-enabled hologram laser tag of claim 1, wherein the metal layer of the hologram substrate is substantially an aluminum coating.

10. The RFID-enabled hologram laser tag of claim 1, wherein the conducting layer is made of a material selected from the group consisting of a conductive metal, and an alloy of a plural conductive metals.

11. The RFID-enabled hologram laser tag of claim 1, wherein the metal layer of the hologram substrate is configured with:
a recess portion, provided for receiving the RFID chip therein while being stridden over by the base of the RFID module; and
at least a groove, extending on the metal layer while having an end thereof channeling to the recess portion.

12. The RFID-enabled hologram laser tag of claim 11, wherein the recess portion is formed along a side of the metal layer in a manner that the side is dented to form a concave.

13. The RFID-enabled hologram laser tag of claim 11, wherein the extending of the groove is defined by a line selected from the group consisting of a straight line, a curved line and the combination thereof.

14. An RFID-enabled hologram laser tag, comprising:
a hologram substrate, including at least a conductive metal layer while each metal layer is configured with a recess portion; and
an RFID chip, being received in the recess portion of the metal layer while enabling the two poles thereof to be electrically connected to the metal layer of the hologram substrate.

15. The RFID-enabled hologram laser tag of claim 14, wherein two legs are formed as the extensions of the metal layer, which are provided for the RFID chip to mount thereon.

16. The RFID-enabled hologram laser tag of claim 14, wherein at least a groove is configured in the metal layer, each of which is extending on the metal layer while having an end thereof channeling to the recess portion.

17. The RFID-enabled hologram laser tag of claim 16, wherein the extending of the groove is defined by a line selected from the group consisting of a straight line, a curved line and the combination thereof.

18. An RFID chip, comprising:
at least a base, made of a non-conductive material;
at least a conducting layer, disposed on the base; and
an RFID chip, arranged on the base while electrically connecting the two poles of the RFID chip to the conducting layer in respective.

19. The RFID-enabled hologram laser tag of claim 18, wherein the conducting layer is configured with two legs that are electrically connected to the two poles of the RFID chip.

20. The RFID-enabled hologram laser tag of claim 19, wherein the conducting layer is shaped as a [symbol] shape, while symmetrically arranging the two legs at the center portion of the conducting layer.

21. The RFID-enabled hologram laser tag of claim 19, wherein the conducting layer is composed of two separate conductive films, and the two legs are respectively formed as the extensions of the two separate conducting films in a symmetrical manner.
